(19) United States
(12) Patent Application Publication
(10) Pub. No.: US 2003/0172758 A1
(43) Pub. Date: Sep. 18, 2003

(54) Load equalization in gear drive mechanism

(76) Inventor: J. Hilbert Anderson, York, PA (US)

Correspondence Address: VENABLE, BAETJER, HOWARD AND CIVILETTI, LLP, P.O. BOX 34385, WASHINGTON, DC, 20043-9998, US

(21) Appl. No.: 10/095,009

(22) Filed: Mar. 12, 2002

(51) Int. Cl. F16H 57/00

(52) U.S. Cl. 74/410

(57) ABSTRACT

In a step-up gear drive mechanism, three gear trains are provided between an input shaft and an output shaft to share the torque transmitted between the input shaft and the output shaft. Each gear train comprises a pinion gear meshing with a central drive gear and mounted on a gear shaft. An output drive gear is threadably mounted on each gear shaft and positioned to mesh with the central output gear. The input drive gear is coaxially mounted on the input drive shaft and the pinion gears support the central drive gear and the distal end of the input drive shaft. The output gear is coaxially mounted on the output drive shaft and the output drive gears support the output gear and the proximal end of the output drive shaft. Collars are threadably mounted on the gear shafts to frictionally engage the output drive gears tending to fix the angular position of the output drive gears on the gear shafts. Set screws are threadably mounted in the collars and are arranged to engage the output drive gears to enable the output drive gears to be fastened more tightly to the gear shafts. To achieve torque equalization the output drive gears are loosely engaged by the collars, the input shaft of the drive mechanism is locked in position, and the output drive shaft is rotated in the reverse direction. This action will cause some of the output drive gears to slip in angular position on the gear shafts so as to equalize the torque transmission through the gear trains. The collars are then fully tightened against the output drive gears and the set screws are tightened against the output drive gears to fasten the output drive gears in position.

This invention relates to a step-up gear drive mechanism designed to drive a compressor wherein the output shaft of the gear drive mechanism is driven at an angular rate of rotation which is a multiple of the input shaft rate of rotation.

In gear drive mechanisms like that of the present invention, it is desirable to reduce the overall size of the mechanism to make it more compact. This size reduction can be accomplished by reducing the size of the gears, but the gears still must be large enough to transmit the required torque. To achieve the gear size reduction without compromising the torque transmission capability of the gear drive mechanism, multiple gear trains are provided between the input shaft and the output shaft. In the mechanism a set of three outer pinion gears are spaced around and arranged to be driven by a central drive gear which is coaxial with and driven by an input shaft. The three pinion gears are fixed to gear shafts, which respectively drive three outer drive gears mounted on the gear shafts. The three outer drive gears mesh with a central output gear which is mounted on the output shaft of the mechanism, which output shaft is also the input shaft of the compressor. Each gear shaft and the pinion gear and drive gear mounted thereon comprises a separate gear train for transmitting torque from the input shaft to the output shaft. If the three gear trains can be arranged so that they share equally the torque transmitted between the input shaft and the output shaft, the size of the gears in the gear drive mechanism can be substantially reduced. However, it is difficult to assure that the transmitted torque is shared equally among the three gear trains. The teeth on the outer gears must be coordinated rotationally with the central drive gear and the output gear so that the pressure on the teeth of the corresponding gears of each gear train is equal among the three gear trains.

In a prior art system, equalization of the torque transmission among the gear trains was achieved by rotationally mounting the outer drive gears on smooth cylindrical surfaces of the drive shafts and frictionally coupling the outer drive gears to the pinion gears. Initially the gears are loosely coupled together so that the outer gears can slip relative to the pinion gears. To adjust the gears so the torque is equalized among the gear trains, the input shaft is locked into position, and with the outer gears loosely coupled together by friction, the output shaft is turned in the reverse direction from which it will be driven by the gear train, causing the coupling between the outer gears to slip and allowing the outer drive gears to turn on the gear shafts until the pressure applied between the engaged teeth in the separate gear trains equalizes. The frictional coupling between the outer gears is then tightened by means of threaded collars and set screws which force the outer drive gears into tight axial engagement with the outer pinion gears. The gears will thus be tightly held in their angular positions relative to the gear shafts so that the torque transmitted through all three gear trains will be equal.

### SUMMARY OF THE INVENTION

The present invention is an improvement over the above-described prior art gear mechanism, in that the outer drive gears are threadably mounted on the gear shafts on which the outer pinion gears are fixed. To hold the outer drive gears in position on the gear shafts, collars are screwed onto the gear shafts to engage the outer drive gears and cause a frictional force to be created between the threads on the outer drive gears and the threads on the gear shafts. In this manner the angular positions of the outer drive gears on the gear shafts can be fixed. In order to produce a high enough friction to transmit the full torque between gear shafts and the outer drive gears, set screws are provided in the collars to exert further axial pressure on the outer drive gears and tightly holding both the outer drive gears and the collars in their angular positions on the gear shafts.

To equalize the torque transmission through the three gear trains, the outer drive gears and the collars are threadably mounted on the gear shafts with the collar engaging the outer drive gears with only a relatively small amount of frictional force, so that the outer drive gears can slip in angular position on the gear shafts. At this point in the process the set screws remain unengaged from the pinion gears. The input shaft of the gear mechanism is locked in position and the output shaft is rotated in the reverse direction from which it will be driven by the gear mechanism in normal operation. This rotation of the output shaft produces forces on the teeth of the gears to transmit torque to the outer drive gears. Since the outer drive gears are not tightly fastened on the gear shafts and can slip relative to the gear shafts, some of the outer drive gears will slip on the gear shafts until the forces exerted on the teeth of the gears are virtually equalized. At this point, the collars are fully tightened against the outer drive gears and the set screws are tightened against the pinion gears to tightly fasten the outer drive gears on the gear shafts.

Because the outer drive gears are threadably mounted on the gear shaft, concentricity of the outer drive gears on the gear shafts is assured, whereas in the prior art system, with the gears slidably mounted on smooth shafts, concentricity and a precise, accurate fit are more difficult to achieve. In addition, a simpler system for achieving the equalization of torque transmission is provided.

### BRIEF DESCRIPTION OF THE DRAWINGS

FIG. 1 is a partial axial sectional view of the gear mechanism of the present invention; and

FIG. 2 is a cross-sectional view taken along the line 2-2 of FIG. 1 with the casing enclosing the gear mechanism removed.

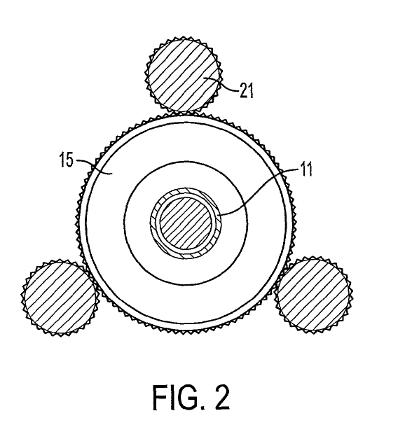

FIG. 3 is an enlarged sectional view of the portion of the mechanism within the circle 3 on FIG. 1.

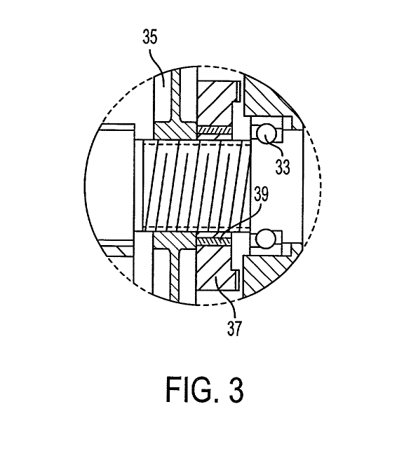

### DESCRIPTION OF A PREFERRED EMBODIMENT

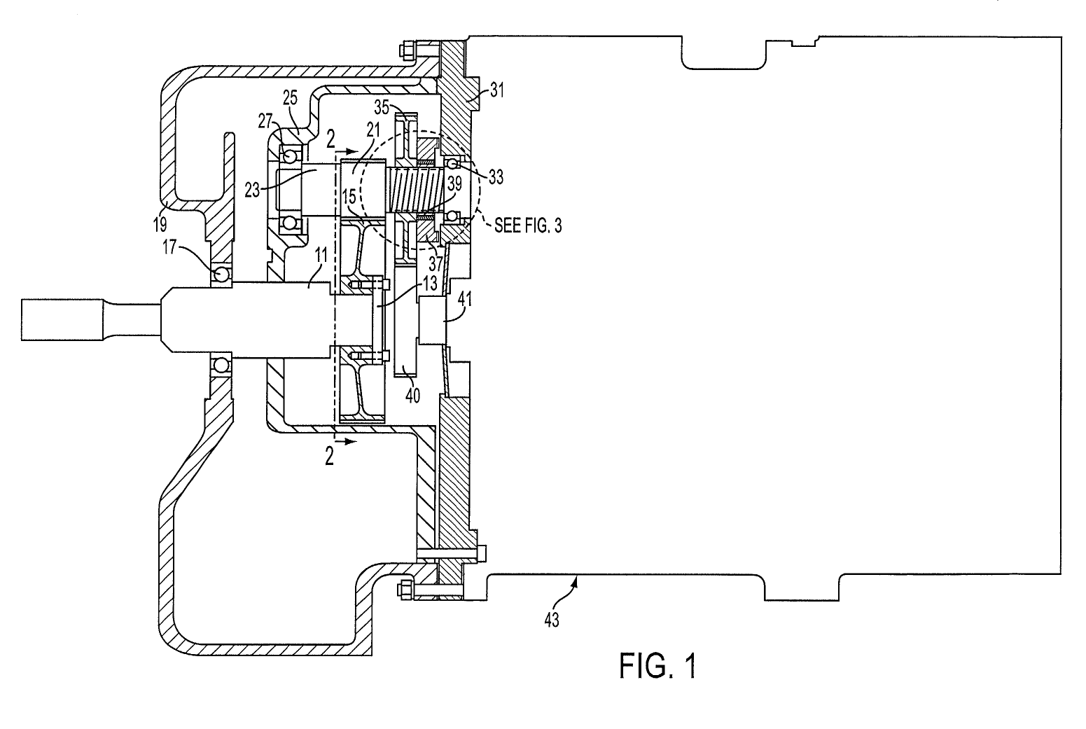

As shown in FIG. 1, the input shaft 11 of the gear mechanism is provided with a flange 13, which is bolted to a central drive gear 15. The input shaft is supported on ball bearings 17 in an outer casing 19 of the gear mechanism. The central drive gear drives a cluster of three outer pinion gears 21 distributed at 120° angular increments around the axis of the driveshaft 11. The gears 21 support the distal end of the driveshaft 11 through the central drive gear 15, providing the same support to the driveshaft 11 that bearings would provide. Since the gears 21 are distributed at equal angular positions, only one of the gears 21 is shown in FIG. 1, but each of the gears 21 is provided in an identical gear train between the input shaft and output shaft of the gear mechanism. Each gear 21 is fixably mounted on and integral with a gear shaft 23, which has its proximal end supported on inner casing 25 by ball bearings 27. The distal end of the gear shaft 23 is supported in an endwall 31 of the gear train enclosure by means of ball bearings 33. The portion of the gear shaft 23 between the bearings 33 and the gear 21 is threaded and a gear 35, provided with threads on an inner cylindrical surface thereof, is threadably mounted on the threads provided on the gear shaft 23. A collar 37 is also threadably mounted on the threads of the gear shaft 23 to frictionally engage the gear 35 to tighten the threads on the gear 35 against the threads on the gear shaft 23 tending to hold the gear 35 in a fixed angular position relative to the shaft 23 in the manner of a lock nut. Eight set screws 39 are threadably mounted in each collar 37 and can be screwed through the collar 37 to engage the gears 35 and further tighten the frictional engagement of the threads on the gear 35 with the threads on the shaft 23 as well as between the threads of the collar 37 and the shaft 23 to tightly hold the gear 35 and the collar 37 in position relative to the shaft 23.

The three gears 35, being mounted on the shafts 23, are axially aligned with the gears 21 and accordingly are distributed at 120° angular increments around the axis of the gear assembly. Gears 35 mesh with a central output gear 40 and support the output gear 40 on the axis of the gear mechanism. The output gear 40 is bolted to an output shaft 41, which is the input shaft of a compressor 43. One end of the shaft 41 is supported on the axis of the gear mechanism by the output gear 40 and the other end of the shaft 41 is supported by bearings (not shown) within the compressor 43.

There is a step-up in the rate of rotation from the gear 15 to the gears 21 and again from the gears 35 to the output gear 40. The two step-ups in rate of angular rotation multiply to drive the output shaft 41 at a high rate of angular rotation and at a multiple of the rate of rotation of the input shaft 11.

In accordance with the invention, to achieve equalization of the torque transmission through the three gear trains between the input shaft and the output shaft, the collars 37 initially only loosely engage the gears 35, so that the gears 35 can slip slightly in their rotational position relative to the gear shafts 23. The set screws 39 threaded into the collars 37, initially, are left disengaged from the gears 35. The input shaft 11 is locked in its angular position and the output shaft 41 is rotated in the reverse direction from which it will be driven in operation. This action exerts a torque on the gears 35 and the gears 35 which receive the greatest torque from the gear 40 will slip slightly relative to the gear shafts 23. This slippage will continue until the forces exerted between the teeth of gear 40 and the teeth of the gears 35 are equalized. At this point the gears 35 will all be angularly positioned on their gear shafts 23 so that the torque transmission through the three gear trains from the central input gear 15 to the output gear 40 will be equalized. To fasten the gears 35 in this correct angular transmission for equal torque transmission, the collars 37 are fully tightened against the gears 35 and the set screws 39 are screwed through the collars 37 to tightly engage the gears 35 to fasten the gears 35 in their correct angular positions.

The input shaft 11 can then be unlocked and the assembled gear mechanism is ready to transmit angular rotation from the input shaft 11 to the output shaft 41 with the torque transmission equalized among the three gear trains.

In the above described system the gears 21 are fixed to the gear shaft 23 and the gears 35 are threadably mounted on the gear shaft 23. Alternatively, the gears 21 could be threadably mounted on the shaft 23 and the gears 35 fixed to the shaft 23, in which case the slippage would occur between the gears 21 and the shafts 23 during the operation to equalize the torque transmission. In the specific embodiment described above, three gear trains are provided between the input shaft and the output shaft of the gear assembly and at least three gear trains need to be provided to fully support the input shaft and the output shaft with the gear trains. The invention is applicable to mechanisms with more than three gear trains between the input shaft and the output shaft and also to mechanisms with only two gear trains between the input shaft and the output shaft. In a two gear train embodiment additional bearings would normally be needed to support the distal end of the input shaft and the proximal end of the output shaft. In the preferred embodiment set screws and collars are used to tighten the outer drive gears 35 on the threads of the shafts 23. Other mechanical mechanisms could be used to perform this tightening function. In the preferred embodiment, the input shaft is locked in position and the output shaft is rotated to correctly position the output drive gears 35 on the gear shafts 23, as this action provides torque to the gears 35 with a mechanical advantage. However, the output shaft could be locked in position and the input shaft rotated to correctly position the outer drive gears 35. In the embodiment specifically described above, the gear mechanism is a step-up mechanism which drives the output shaft at a greater rate of rotation than that of the input shaft. The invention is also applicable to step-down gear mechanisms which drive the output shaft at a slower rate of rotation than that of the input shaft.

These and other modifications may be made to the above described gear train mechanism of the invention without departing from the spirit and scope of the invention, which is defined in the appended claims.

What is claimed is:

1. A gear mechanism comprising an input gear, an output gear, and a plurality of gear trains connected between said input gear and said output gear and each transmitting torque from said input gear to said output gear, said gear trains each comprising a gear shaft, a third gear threadably mounted on said gear shaft, and tightening mechanisms for increasing the pressure between the threads of the third gears and the threads of the gear shafts to functionally hold the third gears in fixed angular positions relative to said gear shaft.

2. A gear mechanism as recited in claim 1 wherein said tightening mechanisms comprise collars threadably mounted on the gear shafts engaging the third gears to hold the third gears in fixed angular positions with respect to the gear shafts.

3. A gear mechanism as recited in claim 2 wherein said tightening mechanisms further comprise set screws threaded through said collars to engage the third gears.

4. A gear mechanism as recited in claim 1 wherein each of said gear trains includes a fourth gear mounted on the corresponding gear shaft and meshing with one of said input and output gears, said third gear of each of said gear trains meshing with the other one of said input and output gears.

5. A gear mechanism as recited in claim 1 wherein said input gear and said output gear are positioned on an axis, said gear mechanism comprising at least three gear trains transmitting torque from said input gear to said output gear and distributed at equal angular intervals around said axis and supporting said input gear and said output gear on said axis.

6. A method of equalizing the torque transmission through a plurality of gear trains in a gear mechanism having an input gear and an output gear, said gear trains being connected between said input gear and said output gear, said gear trains each having a gear shaft and a third gear threadably mounted on said gear shaft, and tightening mechanisms operable to hold the third gears in fixed angular positions relative to the gear shafts by increasing the frictional force between the threads of the third gears and the gear shafts, said method comprising arranging the tightening mechanisms to relatively loosely hold the third gears in position on said gear shafts so that the third gears can slip in their angular positions relative to said gear shafts, holding one of said input and output gears in a fixed position and rotating the other one of said input and output gears to apply torques to the third gears whereby one or more of said third gears slips relative to the corresponding gear shafts until the torque transmitted to said third gears is equalized, and then adjusting said tightening mechanisms to hold said third gears in fixed angular positions relative to said gear shafts.

7. A method as recited in claim 6 wherein said tightening mechanisms comprise collars threadably mounted on the gear shafts, and wherein said tightening mechanisms are adjusted to loosely hold the third gears in position by engaging said collars with said third gears.

8. A method as recited in claim 7 further comprising tightening set screws threaded through said collars against said third gears to fasten said third gears in position with respect to said gear shafts.
